(19) United States
(12) Patent Application Publication
(10) Pub. No.: US 2011/0130124 A1
(43) Pub. Date: Jun. 2, 2011

(54) STATUS PROMPT METHOD AND SYSTEM

(75) Inventors: Hidenari Nozaki, Matsudo-shi (JP); Radim Zemek, Tokyo (JP); Patrice Coupe, Paris (FR)

(73) Assignee: France Telecom, Paris (FR)

(21) Appl. No.: 12/944,850

(22) Filed: Nov. 12, 2010

(30) Foreign Application Priority Data
Dec. 1, 2009 (EP) 09306167.9

(51) Int. Cl. H04M 3/42

(52) U.S. Cl. 455/414.1

(57) ABSTRACT

A method for managing a user equipment in a social communication network, said user equipment comprising a user networking application, said user networking application comprising a configurable user status for displaying the status of the user to other users in the social communication network, said method comprising the acts of activating a status prompt upon a change of state of the user equipment by the user, receiving a user input of a status, and setting the configurable user status using the received user input.

### CROSS-REFERENCE TO RELATED PATENT APPLICATION

This application claims the benefit of European Patent Application No. 09306167.9, filed on Dec. 1, 2009, in the European Patent Office, the entire contents of which is incorporated herein by reference.

### FIELD OF THE INVENTION

The present invention relates in general to telecommunication services and more specifically to user equipment management.

### BACKGROUND

Communication user equipment, in particular mobile phones, are often changed from one state to another, for example, it may be switched on and off or changed from sleep mode to working mode and vice-and-versa. Users have to activate manually the applications they want to use, and particularly their configuration.

There are many popular services on which people post their status, for example, Twitter or Facebook or any instant messenger type of services that allow setting a status. The status allows the user to define his availability or state or mood. For example, status may be “available” or “busy” or “do not disturb” or “back in a minute” or a customized status or sentence such as “I′m angry”.

Entering the status does not consume a lot of time. However, it is a voluntary action as the corresponding applications have to be activated (or switched-on, reactivated, or the like) and the user has to be active and voluntarily enter their status into each application in order to configure the corresponding status when the user equipment changes from one mode or state to another.

The problem with these services is that people often forget to update their status and when they do, they need to voluntarily act on the user equipment to manage applications.

Today, there is no solution to efficiently manage a user equipment when changing from one mode or state to another and thus improving efficiency of such user equipment is needed.

Thus, there is a need for a user equipment management solution that can be easily implemented on the existing communication infrastructures.

### SUMMARY

It is an object of the present system to overcome disadvantages and/or solve the above-noted efficiency problems over the prior art.

To that extent, a method is proposed for managing a user equipment, said user equipment comprising a user networking application, said user networking application comprising a configurable user status for displaying the status of the user to other users in the social communication network, said method comprising, for said user equipment: detecting a change of state of the user equipment triggered by the user; completing the change of state, wherein the act of completing the change of state comprises: activating a status prompt; receiving a user input of a status; and setting the configurable user status using the received user input.

A user equipment is proposed comprising: a user equipment state change detection unit that operates to detect a change of state of the user equipment triggered by the user and complete the change of state; a status unit that operates to activate a status prompt and receive a user input of a status; and an application unit that operates to set the configurable user status using the received user input.

A system is also proposed for managing a user equipment in a social communication network, said system comprising: a social communication network, a user equipment, said user equipment comprising a user networking application, said user networking application comprising a configurable user status for displaying the status of the user to other users in the social communication network, said user equipment being operable to: detect a change of state of the user equipment triggered by the user; complete the change of state; activate a status prompt; receive a user input of a status; and set the configurable user status using the received user input.

A non-transitory computer-readable medium having computer-executable instructions executable on a processor to enable the processor of a computer system to perform the method is also proposed.

An advantage of the various solutions is that, when the user equipment changes from a state to another (e.g., from sleep mode to working mode and vice-and-versa), it prompts the user to interact with a social networking application (or social network application or user networking application) in order to configure his status with regard to said social networking application or user networking application.

Another advantage of the solution is that the choice of application may be based on a user's preference. The user may choose which social networking application he wants to be status prompted for. And, if the user chooses a plurality of social networking applications to be status prompted for, he may be able to choose in which order he will be status-prompted.

Alternatively, a single status prompt may be used by the plurality of social networking applications.

By activating the status prompt upon a change of state, the user will be able to update his status automatically or systematically, so that he does not have to bother with systematically voluntarily thinking of and entering the corresponding application(s) to modify his status. In other words, with the method according to various embodiments of the invention, the user will be passive and will not need any voluntary action to go in the social networking application to update his status.

Various embodiments of the invention may be used with networking applications such as, Twitter, Facebook, or any Instant Messaging program (e.g. Windows Live Messenger) or similar applications.

### BRIEF DESCRIPTION OF THE DRAWINGS

Embodiments of the present invention will now be described solely by way of example and only with reference to the accompanying drawings, where like parts are provided with corresponding reference numerals, and in which:

FIG. 1 is a block diagram that schematically illustrates a system according to an embodiment of the present invention;

FIG. 2 is a block diagram that schematically illustrates a method according to an embodiment of the present invention;

FIG. 3a is a block diagram that schematically illustrates a user equipment according to an embodiment of the present invention; and

FIG. 3b is a block diagram that schematically illustrates a user equipment according to an embodiment of the present invention.

### DETAILED DESCRIPTION

The following are descriptions of exemplary embodiments that when taken in conjunction with the drawings will demonstrate the above noted features and advantages, and introduce further ones.

In the following description, for purposes of explanation rather than limitation, specific details are set forth such as architecture, interfaces, techniques, devices, and the like, for illustration. However, it will be apparent to those of ordinary skill in the art that other embodiments that depart from these details would still be understood to be within the scope of the appended claims.

Moreover, for the purpose of clarity, detailed descriptions of well-known devices, systems, and methods are omitted so as not to obscure the description of the present system. Furthermore, operating system and applications in a user equipment, and routers, servers, nodes, gateways or other entities in a social communication network are not detailed as their implementation is beyond the scope of the present system and method.

Unless specified otherwise, the exemplary embodiment will be described hereafter in its application to a user equipment of a social communication network.

In addition, it should be expressly understood that the drawings are included for illustrative purposes and do not represent the full scope of the present system.

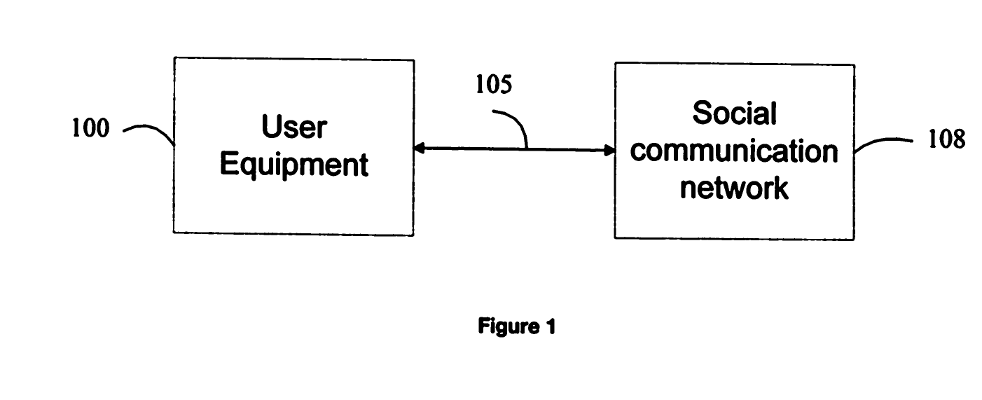

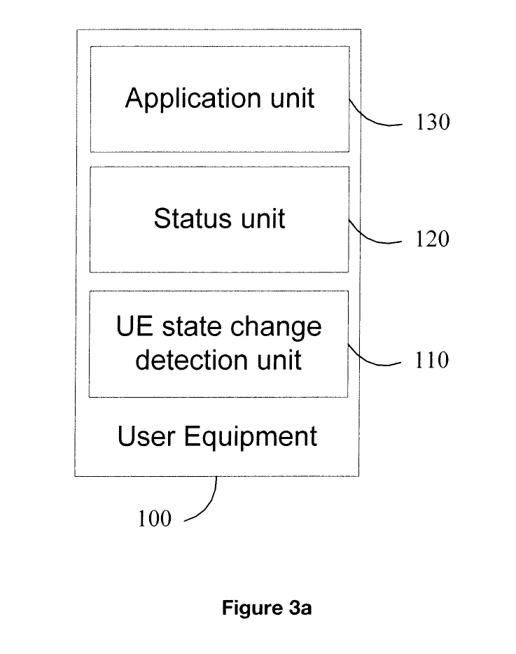

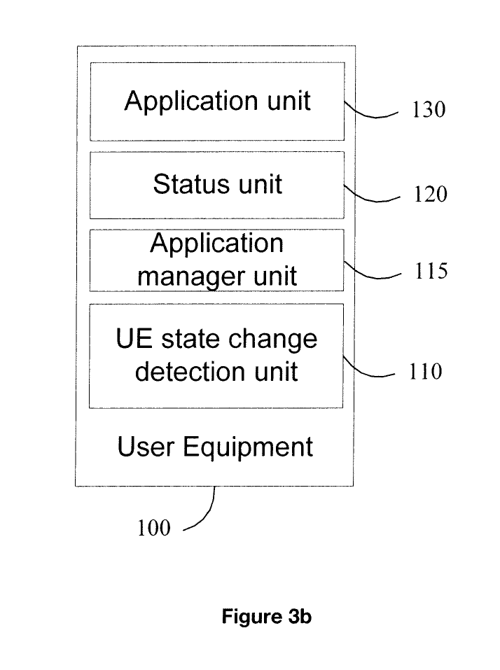

FIG. 1 describes a system according to an embodiment of the invention. A user equipment 100 may communicate via a link 105 in a communication network 108. The system for managing a user equipment 100 in a social communication network 108 comprises a social communication network 108, and, as described here under in reference to FIGS. 3a and 3b, a user equipment 100 comprising a user networking application. The user networking application comprises a configurable user status for displaying the status of the user to other users in the social communication network 108. The user equipment 100 is operable to activate a status prompt upon a change of state of the user equipment by the user, receive a user input of a status, and set the configurable user status using the received user input.

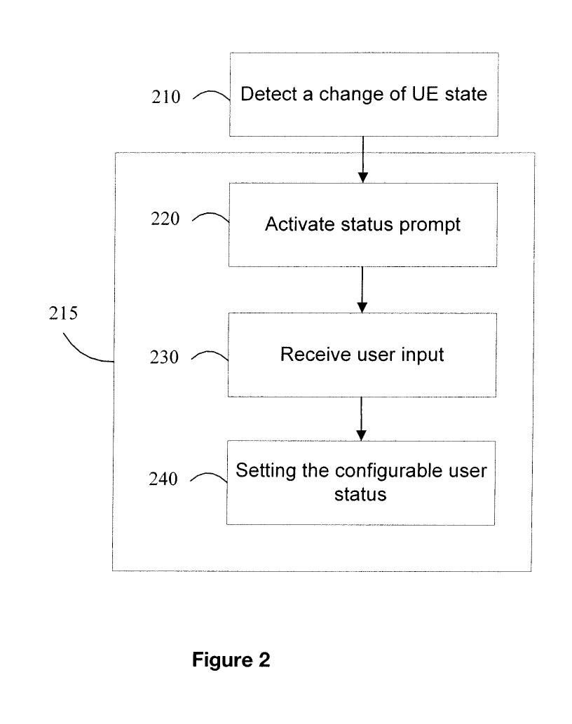

FIG. 2 describes an illustrative embodiment of the method according to the invention. The method allows managing a user equipment in a social communication network. The user equipment comprises a user networking application. The network application comprises a configurable user status for displaying the status of the user to other users in the social communication network.

First, a change of state of the user equipment triggered by the user is detected in module 210 as described hereunder. Then, during process element 215 of completing the change of state, a status prompt is activated in module 220. Then, a user input of a status is received in module 230. The configurable user status is set using the received user input in module 240. Then, the user equipment 100 may, for example, switch to its usual home screen or the screen the user left off before the user equipment went to sleep mode or got shut off.

In the method according to various embodiments of the invention, the change of state may be an activation of the user equipment. When the change of state is an activation of the user equipment, the activation of the user equipment may correspond, for example, to switching-on the user equipment or to an activation of the user equipment from the sleep mode. For instance, when switching-on or waking-up from sleep mode, the user equipment displays a status prompt to ask the user to update his status for one or a plurality of social networking application. In this case, the status prompt is displayed after activating the user equipment to enter in running state or mode from switched-off or idle/sleep mode (e.g., after pressing the on button or touching the screen or a key) and before the user may interact with the user interface to act on other functions or applications of the user equipment. In other words, the user status input received in module 230 is the first interaction the user may have with the user equipment subsequent to the trigger of change of state of said user equipment.

The change of state may also be a deactivation of the user equipment. In this case, the deactivation of the user equipment may correspond, for example, to switching-off the user equipment or to a deactivation of the user equipment to the sleep mode. When switching-off or going into sleep mode, the user equipment displays a status prompt to ask the user to update his status for one or a plurality of social networking application. In this case, the status prompt is displayed after activating the user equipment toward switching-off state or mode or toward idle state or mode (e.g., after pressing the off button or not touching the screen or a key for some time) and before the user equipment enters said switching-off state or mode or toward idle state or mode.

The user equipment may comprise a plurality of networking applications. In this case, the status prompt may at once allow the configuration of all the configurable user statuses of the plurality of networking applications. In other words, a single status prompt may be activated in order to set or configure each configurable user status for all networking applications. In an alternative embodiment, the status prompt may also allow a different configuration for each of the configurable user statuses of each networking application. In other words, a plurality of status prompts may be used, for example one status prompt per networking application. In this case, in an optional embodiment, it may be possible for the user to configure his user's preferences. The user's preferences may allow selecting the order in which the status prompts of the plurality of networking applications is displayed or which status prompt of the plurality of networking applications may be displayed.

FIGS. 3a and 3b describe a user equipment according to various embodiments of the invention. The user equipment is in a social communication network and comprises a user networking application. The user networking application comprises a configurable user status for displaying the status of the user to other users in the social communication network. The user equipment is operable to detect a change of state of the user equipment triggered by the user and complete the change of state. The act of completing the change of state comprises activating a status prompt, receiving a user input of a status, and setting the configurable user status using the received user input.

As described in FIG. 3a, the user equipment 100 may comprise a state change detection unit 110 operable to change the state of the user equipment by the user, a status unit 120 operable to activate a status prompt upon a change of state of the user equipment by the user and receive a user input of a status, and an application unit 130 operable to set the configurable user status using the received user input. The state change detection unit 110 handles the change of state request or trigger from the user.

The status unit may be managed by the operating system (OS) of the user equipment. In such a case, the OS may be configured to activate the status prompt. An OS uses processes to control, and particularly to trigger, applications. A process is a software routine that performs some action and may be controlled by a user, by other applications or by the operating system. It comprises processes, rather than applications, that the operating system controls and schedules for execution by the Central Processing Unit (CPU). The operating system allows the application to begin running, suspending the execution only long enough to deal with interrupts and user input. The UE state change unit detection 110 is configured for the user of the user equipment to change its state, for example, from sleep mode to running mode or vice-and-versa, for instance, by pressing a on-off button or a key or touching a screen or waiting to go into idle mode, and the like. The UE state change unit detection 110 is also configured for completing the change of state of the user equipment. Upon changing its state, the OS , which may be part of the UE state change unit detection 110, runs a process that launches a status prompt program. The status prompt program may be a piece of software stored in the status unit 120. The status prompt program may be created, for instance, using an Application Program Interface (API). The status prompt program allows displaying a status prompt for asking the user to input his status for display to other users of the social communication network. The status prompt receives the input of the user and communicates it to the application unit 130. The application unit 130 allows storing networking applications. The input of the user is used by the application unit 130 to set the configurable user status of networking applications. The configurable user status is the status of the user that is displayed to other users in the social communication network 108. In the method according to various embodiments of the invention, the configurable user status of networking applications may be set or stored (module 240 in reference to FIG. 2) during the completion of the change of state. It may be applied either in real time in the networking application(s) of the application unit 130 if said network application(s) is/are running (i.e., activated) or may be stored in the application unit 130 for further use by the network applications when they will be activated.

In an alternative embodiment, the status unit 120 may also managed by the application unit 130. In this case, the OS or the UE state change unit 110 may send a command to the application unit 130 to launch the status prompt program stored in the status unit 120. The status prompt program allows displaying a status prompt for asking the user to input his status for display to other users of the social communication network. The status prompt receives the input of the user and communicates it to the application unit 130. The application unit 130 allows storing networking applications. The input of the user is used by the application unit 130 to either store or apply the configurable user status of networking applications. The configurable user status is the status of the user that is displayed to other users in the social communication network 108.

In an alternative embodiment of the user equipment as described in FIG. 3b, the user equipment 100 may further comprise an application manager operable 115 to manage the status unit 120 and/or the application unit 130. In this case, the OS or the UE state change unit 110 may send a command to the application manager unit 115 to launch the status prompt program stored in the status unit 120. The application manager unit 115 may then send command messages to the status unit 120 and/or to the application unit 130 to launch the status prompt program. The status prompt program allows displaying a status prompt for asking the user to input his status for display to other users of the social communication network. The status prompt receives the input of the user and communicates it to the application unit 130. The application unit 130 allows storing networking applications. The input of the user is used by the application unit 130 to set the configurable user status of networking applications. The configurable user status is the status of the user that is displayed to other users in the social communication network 108.

In an alternative embodiment, some of the user networking applications stored as clients on the user equipment 100 and remotely managed by a remote application server in the social communication network 108. The input of the user received in module 230 (in reference to FIG. 2) may then be sent by the application unit 130 to the remote application server for subsequent display of the status of the user to the other users of the social communication network 108.

As opposed to existing solutions, where a status prompt is displayed by the networking application, in the user equipment according to various embodiments of the invention, the status prompt is displayed upon request from the operating system. The status prompt may be displayed upon request from the operating system to either:
the status unit 120 directly, or in this case the operating system, manages the status unit 120,
the application manager unit 115 that further requests the status unit 120 or,
the application unit 130 that further requests the status unit 120.

### Use Cases

The following use cases illustrate applications of various embodiments of the invention.
Alice is waiting for a bus. She notices that her bus is late. So, she checks her RSS reader for any latest news. She touches a key to reactivate her phone. The phone shows a Twitter application for her to enter her current status as she sets her reactivation prompt to Twitter. After updating her status, she starts reading RSS feeds.
People turn off their mobile phones before some event that should not be interrupted by calls; for example, meetings, conferences, movie theaters, wedding ceremonies, and so on. What many people do is to update their user status before the event, and then they turn off their mobile devices. However, people often forget to do the update, but they do not forget to turn off their phones, as this is more crucial than updating the status. To bridge that gap between these two actions is this solution. When the user turn off their mobile device, it prompts the user to update her status for her preferred social network services. After the event finishes, when the user turns her mobile device on, it should also prompt the user for what her current status is.

A method is provided for managing a user equipment in a communication network, said user equipment comprising at least one user networking application, said at least one user networking application comprising a configurable user status for configuring the status of the user, said method comprising the act of activating a status reactivation prompt upon activation of the user equipment, said status reactivation prompt being configured to set up (the configuration of) the configurable user status (or allowing the configuration of the configurable user status).

A method is provided for managing a user equipment in a communication network, said user equipment comprising a user networking application, said networking application comprising a configurable status for configuring the application, said method comprising the act of activating a configuration prompt upon activation of the user equipment, said configuration prompt allowing the configuration of the configurable status.

A method is provided for managing a user equipment in a communication network, said user equipment comprising a user networking application, said networking application comprising a configurable status for configuring the application, said method comprising the act of activating a configuration prompt upon deactivation of the user equipment, said configuration prompt allowing the configuration of the configurable status.

A user equipment in a social communication network is provided, said user equipment comprising a user networking application, said user networking application comprising a configurable user status for displaying the status of the user to other users in the social communication network, said user equipment being operable to:

activate a status prompt upon a change of state of the user equipment by the user,

receive a user input of a status,

set the configurable user status using the received user input.

The user equipment may operate so that the change of state is an activation of the user equipment.

The user equipment may operate so that the activation of the user equipment corresponds to switching-on the user equipment or to an activation of the user equipment from the sleep mode.

The user equipment may operate so that the change of state is a deactivation of the user equipment.

The user equipment may operate so that the deactivation of the user equipment corresponds to switching-off the user equipment or to an deactivation of the user equipment to the sleep mode.

The user equipment may comprise a plurality of networking applications and wherein the status prompt allows at once the configuration of all the configurable user status of the plurality of networking applications.

The user equipment may comprise a plurality of networking applications and wherein the status prompt allows a different configuration for each of the configurable user status of each networking application.

The user equipment may be further operable to configure the user's preferences, said user's preferences allowing selecting the order in which the status prompts of the plurality of networking applications is displayed or which status prompt of the plurality of networking applications may be displayed. The system or systems described herein may be implemented on any form of computer or computers and the components may be implemented as dedicated applications or in client-server architectures, including a web-based architecture, and can include functional programs, codes, and code segments. Any of the computers may comprise a processor, a memory for storing program data and executing it, a permanent storage such as a disk drive, a communications port for handling communications with external devices, and user interface devices, including a display, keyboard, mouse, etc. When software modules are involved, these software modules may be stored as program instructions or computer readable codes executable on the processor on a computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media is readable by the computer, stored in the memory, and executed by the processor.

All references, including publications, patent applications, and patents, cited herein are hereby incorporated by reference to the same extent as if each reference were individually and specifically indicated as incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components that perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The use of the terms “a” and “an” and “the” and similar referents in the context of describing the invention (especially in the context of the following claims) should be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein are performable in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the present invention.

1. A method for managing a user equipment in a social communication network, said user equipment comprising a user networking application, said user networking application comprising a configurable user status for displaying the status of the user to other users in the social communication network, said method comprising, for said user equipment:
detecting a change of state of the user equipment triggered by the user;
completing the change of state, wherein the act of completing the change of state comprises:
activating a status prompt;
receiving a user input of a status; and
setting the configurable user status using the received user input.

2. The method according to claim 1, wherein the change of state is an activation of the user equipment.

3. The method according to claim 2, wherein the activation of the user equipment corresponds to a switching-on of the user equipment or to an activation of the user equipment from the sleep mode.

4. The method according to claim 1, wherein the change of state is a deactivation of the user equipment.

5. The method according to claim 4, wherein the deactivation of the user equipment corresponds to switching-off the user equipment or to a deactivation of the user equipment to the sleep mode.

6. The method according to claim 1, wherein the user equipment comprises a plurality of networking applications and wherein the status prompt causes the user equipment to configure at once the configuration of all configurable user status of the plurality of networking applications.

7. The method according to claim 1, wherein the user equipment comprises a plurality of networking applications and wherein the status prompt allows a different configuration for each of the configurable user status of each networking application.

8. The method according to claim 7, said method further comprising:
configuring, in a preliminary act, the user's preferences, said user's preferences allowing selecting an order in which the status prompts of the plurality of networking applications is displayed or which status prompt of the plurality of networking applications may be displayed.

9. A user equipment, said user equipment comprising:
a user equipment state change detection unit that operates to detect a change of state of the user equipment triggered by the user and complete the change of state;
a status unit that operates to activate a status prompt and receive a user input of a status; and
an application unit that operates to set the configurable user status using the received user input.

10. The user equipment according to claim 9, wherein the status unit is managed by the operating system of the user equipment.

11. The user equipment according to claim 9, wherein the status unit is managed by the application unit.

12. The user equipment according to claim 9, said user equipment further comprising:
an application manager that operates to manage at least one of the status unit and the application unit .

13. The user equipment according claim 9, said user equipment being operable to carry out a method for managing a user equipment in a social communication network:
said user equipment comprising:
a user networking application, said user networking application comprising a configurable user status for displaying the status of the user to other users in the social communication network;
said method comprising, for said user equipment:
detecting a change of state of the user equipment triggered by the user; and
completing the change of state;
wherein the act of completing the change of state comprises:
activating a status prompt;
receiving a user input of a status; and
setting the configurable user status using the received user input.

14. A system for managing a user equipment in a social communication network, said system comprising:
a social communication network,
a user equipment, said user equipment comprising a user networking application, said user networking application comprising a configurable user status for displaying the status of the user to other users in the social communication network, said user equipment being operable to:
detect a change of state of the user equipment triggered by the user;
complete the change of state;
activate a status prompt;
receive a user input of a status; and
set the configurable user status using the received user input.

15. A non-transitory computer-readable medium having computer-executable instructions executable on a processor to enable the processor of a computer system to perform the method of claim 1.
